(19) United States
(12) Patent Application Publication
(10) Pub. No.: US 2025/0269908 A1
(43) Pub. Date: Aug. 28, 2025

(54) VEHICLE REAR STRUCTURE

(71) Applicants: Yukihiro HAMADA, Nisshin-shi Aichi-ken (JP); Akira MISHIMA, Ogaki-shi Gifu-ken (JP)

(72) Inventors: Yukihiro HAMADA, Nisshin-shi Aichi-ken (JP); Akira MISHIMA, Ogaki-shi Gifu-ken (JP)

(73) Assignees: TOYOTA JIDOSHA KABUSHIKI KAISHA, Toyota-shi Aichi-ken (JP); PACIFIC INDUSTRIAL CO., LTD., Ogaki Gifu (JP)

(21) Appl. No.: 19/062,775

(22) Filed: Feb. 25, 2025

(30) Foreign Application Priority Data
Feb. 28, 2024 (JP) 2024-029166

(51) Int. Cl. B62D 25/20; B62D 25/18

(52) U.S. Cl. CPC B62D 25/2027; B62D 25/18; B62D 25/2036

(57) ABSTRACT

A vehicle rear structure includes: a first pillar defining a rear end edge of a side door opening; a second pillar defining an interface between a rear surface and a side surface of a vehicle; a lamp housing connected to a lower end of the second pillar; a wheel well disposed between and connected to the first pillar and the lamp housing; and a roof side inner portion filling, without a gap, an area enclosed by the first pillar, the second pillar, the lamp housing, and the wheel well.

### CROSS REFERENCE TO RELATED APPLICATION

This application claims priority to Japanese Patent Application No. 2024-029166 filed on Feb. 28, 2024, which is incorporated herein by reference in its entirety including the specification, claims, drawings, and abstract.

### TECHNICAL FIELD

The present specification discloses a rear structure of a vehicle.

### BACKGROUND

Design panels such as a rear bumper panel, quarter panels, and rear fender panels are provided on the upper side of rear wheels of a vehicle. In the related art, the design panels are made of metal and joined to other surrounding members. Joint lines are sufficiently sealed. Accordingly, liquid tightness is ensured by the design panels, and thus the liquid tightness of parts disposed on the inner side of the design panels has not been adequately considered in the related art.

For example, Patent Document 1 discloses a vehicle provided with sidewall portions constituting side surfaces of a vehicle body. In Patent Document 1, a large opening is formed in each of the sidewall portions. However, in the case of Patent Document 1, design panels having liquid tightness are disposed outside the sidewall portions. Thus, according to the vehicle in Patent Document 1, entry of rainwater into a passenger compartment can be prevented.

### CITATION LIST

PATENT DOCUMENT 1: JP 2007-38983 A

Here, in some examples, it has been proposed that a design panel be made of resin instead of metal. A design panel made of resin has a higher degree of freedom in molding and is lighter than a design panel made of metal. For this reason, the use of a design panel made of resin can improve the degree of freedom in vehicle design and reduce the weight of a vehicle.

On the other hand, a design panel made of resin has a thermal expansion coefficient different from that of metal, and cannot be easily attached to a vehicle body in a liquid-tight manner. For this reason, when design panels made of resin are used in a vehicle in which a hole is formed in sidewall portions as in Patent Document 1, liquid tightness cannot be ensured and entry of raindrops into a passenger compartment cannot be prevented.

Therefore, the present specification discloses a vehicle rear structure that can ensure the liquid tightness of a passenger compartment even when the liquid tightness cannot be ensured by design panels.

### SUMMARY

A vehicle rear structure disclosed in the specification includes: a first pillar defining a rear end edge of a side door opening; a second pillar defining an interface between a rear surface and a side surface of a vehicle; a lamp housing connected to a lower end of the second pillar; a wheel well disposed between and connected to the first pillar and the lamp housing; and a roof side inner portion filling, without a gap, an area enclosed by the first pillar, the second pillar, the lamp housing, and the wheel well.

With this configuration, the roof side inner portion fills, without a gap, the area enclosed by the first pillar, the second pillar, the lamp housing, and the wheel well. Accordingly, the liquid tightness of a passenger compartment can be ensured even when the liquid tightness cannot be ensured by design panels.

In this case, a vent duct communicating between an interior and an exterior of the vehicle may be further included, and the wheel well may include a wheel arch portion along a circumferential surface of a rear wheel, and a flange portion projecting outward in a radial direction of the rear wheel from the wheel arch portion, and the vent duct may be disposed at the flange portion and below a trunk board.

With this configuration, entry of water, dust, and noises through the vent duct can be effectively prevented.

In addition, a circumferential edge of the roof side inner portion is joined to the first pillar, the second pillar, and the wheel well, and one or more sealing members are provided at a plurality of joints between the roof side inner portion and other members. The number of sealing members provided at joints facing upward when viewed from the outside of the vehicle out of the plurality of joints may be greater than the number of the sealing members provided at joints facing downward when viewed from the outside of the vehicle out of the plurality of joints.

With this configuration, costs, time, and effort required for sealing can be reduced while ensuring sufficient liquid tightness.

In addition, a roof header defining an upper edge of a back door opening, a rear end defining a lower edge of the back door opening, and a weatherstrip attached to a circumferential edge of the back door opening may be further included. Each of upper ends of a pair of second pillars, each identical to the second pillar, may be joined to a respective one of both ends of the roof header in a vehicle width direction. Each of lower ends of a pair of lamp housings, each identical to the lamp housing, may be joined to a respective one of both ends of the rear end in the vehicle width direction. The second pillar may include a rear flange which projects toward the outside of the vehicle and is sealed by the weatherstrip.

With this configuration, the rear flange functions as a barrier that prevents raindrops streaming down the surface of the second pillar from reaching the back door opening. Thus, it is no longer necessary to provide a separate gutter-like member, and the second pillar can be thickened accordingly. Since the second pillar is thickened, the rigidity of the periphery of the back door opening is increased.

In addition, a design panel that covers at least the roof side inner portion from the outside and constitutes an outer surface of the vehicle may be further included, and the design panel may be made of resin.

With the design panel made of resin, the weight of the vehicle is reduced and the degree of freedom in design is increased.

According to the vehicle rear structure disclosed in the specification, the roof side inner portion fills, without a gap, the area enclosed by the first pillar, the second pillar, and the wheel well. Accordingly, the liquid tightness of the passenger compartment can be ensured even when the liquid tightness cannot be ensured by design panels.

### BRIEF DESCRIPTION OF DRAWINGS

Embodiment(s) of the present disclosure will be described based on the following figures, wherein:

FIG. 1 is a perspective side view of the rear of a vehicle;

FIG. 2 is a perspective rear view of the rear of the vehicle;

FIG. 3 is a cross-sectional view taken along a line A-A in FIG. 1;

FIG. 4 is a schematic cross-sectional view taken along a line B-B in FIG. 2;

FIG. 5 is a diagram for explaining orientation of joint lines and sealing structures; and

FIG. 6 is a schematic cross-sectional view of the periphery of a second pillar in a vehicle in the related art.

### DESCRIPTION OF EMBODIMENTS

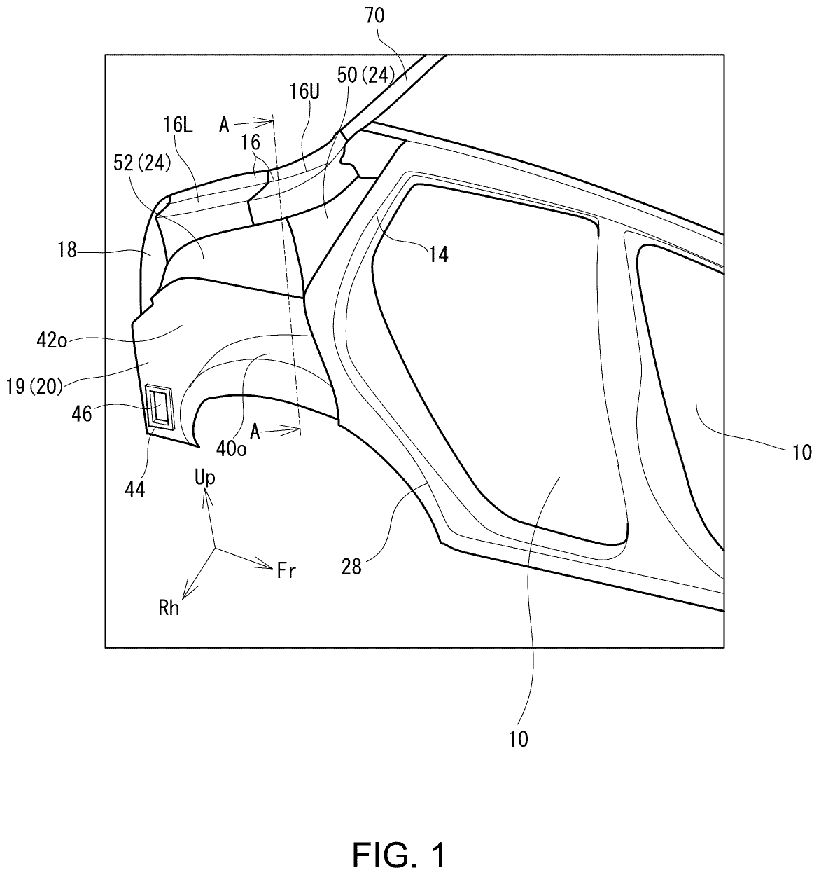

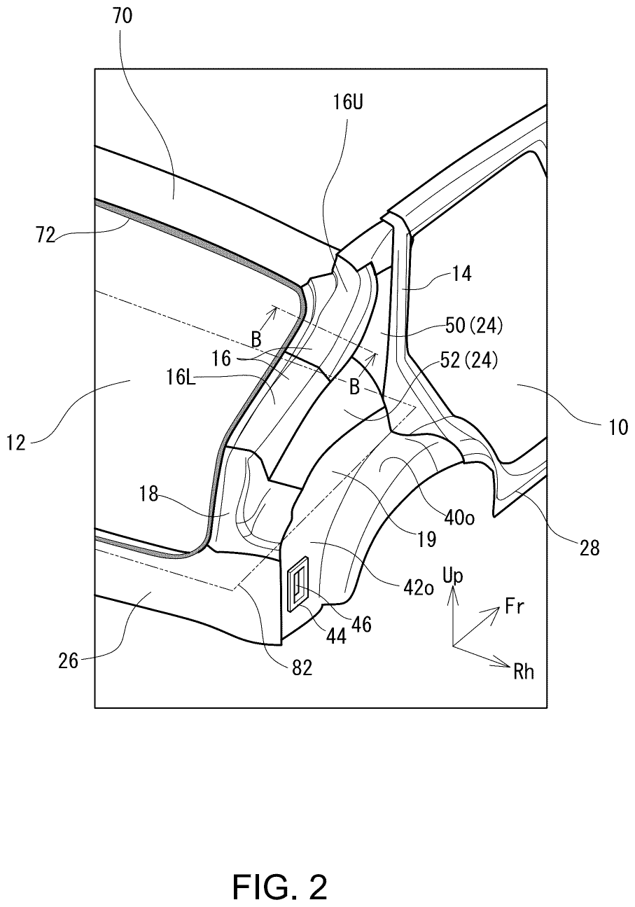

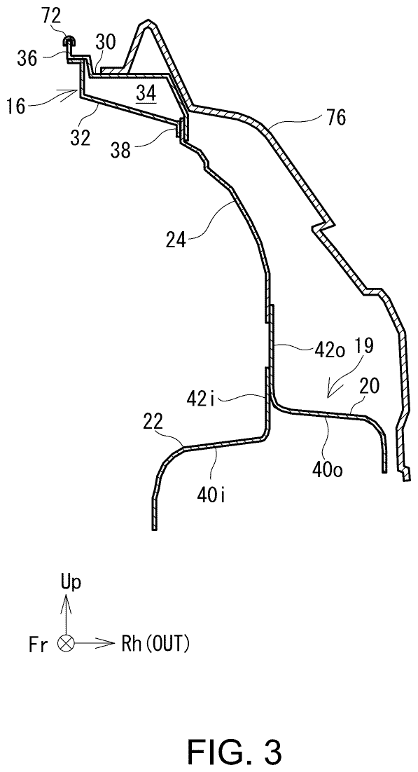

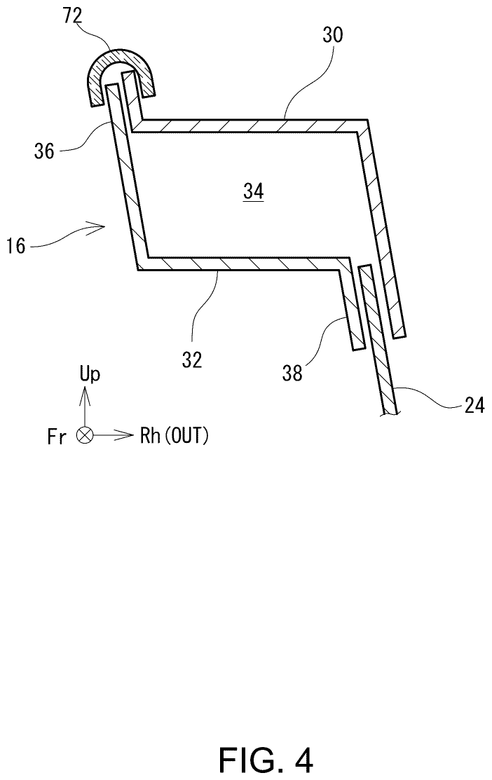

Hereinafter, a vehicle rear structure will be described with reference to the accompanying drawings. FIG. 1 is a perspective side view of the rear of a vehicle. FIG. 2 is a perspective rear view of the rear of the vehicle. FIG. 3 is a cross-sectional view taken along a line A-A in FIG. 1, and FIG. 4 is a cross-sectional view taken along a line B-B in FIG. 2. In each drawing, “Fr”, “Up”, and “Rh” refer to a front side, an upside, and a right side of the vehicle, respectively.

In the vehicle described below, the outer surface is formed of a design panel 76 (see FIG. 3) made of resin, instead of a design panel made of metal. That is, design panels made of metal such as a “rear bumper panel”, a “quarter panel”, and a “rear fender panel” are attached to a side surface of the rear of a vehicle in the related art. In the present example, instead of these design panels made of metal, the design panel 76 made of resin is employed. The design panel 76 made of resin will be described in detail below. It should be noted that the design panel 76 made of resin is omitted in FIG. 1 and FIG. 2.

As illustrated in FIG. 1, a side door opening 10 is formed in the rear of the vehicle. In the example of FIG. 1, two side door openings 10 are formed side by side in a front-back direction. However, the technique disclosed in the specification may be applied to a vehicle in which only one side door opening 10 is provided on each of right and left sides.

The circumferential edge of the side door opening 10 is covered with an opening panel 28. The opening panel 28 is a large-sized panel member molded to fit the shape of the side door opening 10. The opening panel 28 includes a first pillar 14. The first pillar 14 is a frame member extending downward from the roof of the vehicle and defines a rear end edge of the side door opening 10. The first pillar 14 is, for example, a substantially square tubular member with a closed cross section. The first pillar 14 is formed, for example, by joining an outer panel and an inner panel to each other. A lower end of the first pillar 14 is joined to a wheel well 19 to be described below.

A back door opening 12 is formed in a rear surface of the vehicle. An upper edge of the back door opening 12 is defined by a roof header 70 and a lower edge of the back door opening 12 is defined by a rear end 26. The roof header 70 and the rear end 26 are frame members made of metal and extending in a vehicle width direction.

A second pillar 16 is joined to both ends of the roof header 70 in the vehicle width direction. The second pillar 16 is a frame member that defines an interface between the rear surface and the side surface of the vehicle. Similar to the first pillar 14, the second pillar 16 is a substantially square tubular member with a closed cross section. It should be noted that, in the present example, the second pillar 16 is divided into a plurality portions in the vertical direction. Specifically, the second pillar 16 includes a second pillar upper 16U joined to the roof header 70 and a second pillar lower 16L joined to the lower end of the second pillar upper 16U. However, of course, the second pillar 16 is not necessarily divided in the vertical direction.

A lamp housing 18 is disposed between the second pillar 16 and the rear end 26. The lamp housing 18 is a member to which a rear lamp unit (not illustrated) is attached. The lamp housing 18 is formed with a cavity in which the rear lamp unit is accommodated. The lamp housing 18 is formed by joining an outer panel and an inner panel to each other. The outer panel and the inner panel form a closed cross section. The closed cross section of the lamp housing 18 is connected to the closed cross section of the second pillar 16. In other words, the lamp housing 18 can be regarded as a frame member that defines, together with the second pillar 16, an edge of an end portion of the back door opening 12 in the vehicle width direction.

A plurality of panel members are disposed between the first pillar 14 and the second pillar 16. The plurality of panel members function as partition walls that separate the interior and the exterior of a passenger compartment from each other. Specifically, the wheel well 19 and a roof side inner portion 24 are disposed between the two pillars 14, 16. The wheel well 19 is a member that covers a rear wheel from above. As illustrated in FIG. 3, the wheel well 19 includes a wheel well outer portion 20 projecting outward in the vehicle width direction and a wheel well inner portion 22 projecting inward in the vehicle width direction. The wheel well outer portion 20 and the wheel well inner portion 22 include wheel arch portions 400, 40i, respectively, and include flange portion 420, 42i, respectively, the wheel arch portions 400, 40i being along a circumference surface of the rear wheel (not illustrated), the flange portion 420, 42i extending outward in a radial direction of the rear wheel from the wheel arch portions 400, 40i, respectively. The wheel well 19 is formed by joining the flange portion 42i of the wheel well inner portion 22 to the flange portion 420 of the wheel well outer portion 20.

As illustrated in FIG. 3, in the present example, the roof side inner portion 24, which will be described below, is joined to the flange portion 420 of the wheel well outer portion 20. However, the roof side inner portion 24 may be joined to the flange portion 42i of the wheel well inner portion 22 instead of the flange portion 420 of the wheel well outer portion 20. For this reason, in the following description, when either the flange portion 420 or the flange portion 42i is acceptable, they are referred to as “the flange portion 42” with suffixes i and o omitted. The same applies to the wheel arch portions 400, 40i.

The roof side inner portion 24 is a panel member that fills, without a gap, an area enclosed by the first pillar 14, the wheel well 19, the lamp housing 18, and the second pillar 16. The roof side inner portion 24 and the flange portion 42 function as partitions that separate the interior and the external of the vehicle from each other. In the present example, the roof side inner portion 24 is divided into a front side roof side inner portion 50 and a rear side roof side inner portion 52. The reason the roof side inner portion 24 is divided into two portions is to reduce weight while ensuring rigidity. That is, a member near the side door opening 10 needs to be thickened so as to maintain the rigidity thereof. However, if the entirety of the roof side inner portion 24 is thickened, the weight and the cost thereof increase accordingly. Thus, in the present example, the roof side inner portion 24 is divided into the front and rear portions, and the thickness of the front side roof side inner portion 50 closer to the side door opening 10 is made greater than the thickness of the rear side roof side inner portion 52.

Incidentally, in the related art, design panels made of metal such as a rear bumper panel and quarter panels are disposed outside the roof side inner portion 24 in the vehicle width direction. These design panels made of metal are directly or indirectly joined to vehicle frame members. Then, each joint line is provided with a sealing structure (e.g., paint seal) for preventing the entry of raindrops.

When these design panels made of metal are used, waterproofing performance is ensured by these design panels. Accordingly, even when a hole is formed in the roof side inner portion 24 or a gap is present between the roof side inner portion 24 and another member, the entry of water into a passenger compartment is prevented.

On the other hand, in the present example, instead of design panels made of metal, the design panel 76 made of resin is employed as described above. The use of the design panel 76 made of resin reduces the weight of the vehicle. In addition, the use of the design panel 76 made of resin also reduces man-hours for painting. Consequently, CO2 emissions are reduced. Further, since resin has a higher degree of freedom in molding than metal, the design panel 76 made of resin increases the degree of freedom in designing of the vehicle. The design panel 76 made of resin is attached to the vehicle body with a fastening member such as a clip, and thus can be attached to and detached from the vehicle body. Accordingly, with the design panel 76 made of resin, the design of the vehicle can be more easily changed as compared to the case where a design panel made of metal is used. For example, when the design panel 76 made of resin is employed, the appearance of the vehicle can be made “exchangeable”.

On the other hand, the resin constituting the design panel 76 has an expansion coefficient significantly different from the expansion coefficient of the metal constituting the roof side inner portion 24, the pillars 14, 16, and the like. Thus, the design panel 76 cannot be joined to a metal part such as the roof side inner portion 24. As a result, liquid tightness between the design panel 76 and the vehicle body cannot be ensured and there is a possibility of entry of raindrops into the passenger compartment.

For this reason, in the vehicle of the present example, the roof side inner portion 24 fills, without a gap, the area enclosed by the first pillar 14, the wheel well 19, the lamp housing 18, and the second pillar 16 as described above. In addition, a sealing structure (e.g., a paint seal) is provided over the entire circumferential edge of the roof side inner portion 24. Similarly, the sealing structure is provided at joint lines between the first pillar 14 and other members, joint lines between the lamp housing 18 and other members, joint lines between the wheel well 19 and other members, and the like. Accordingly, the liquid tightness in the rear of the vehicle can be ensured and the entry of raindrops into the passenger compartment can be effectively prevented.

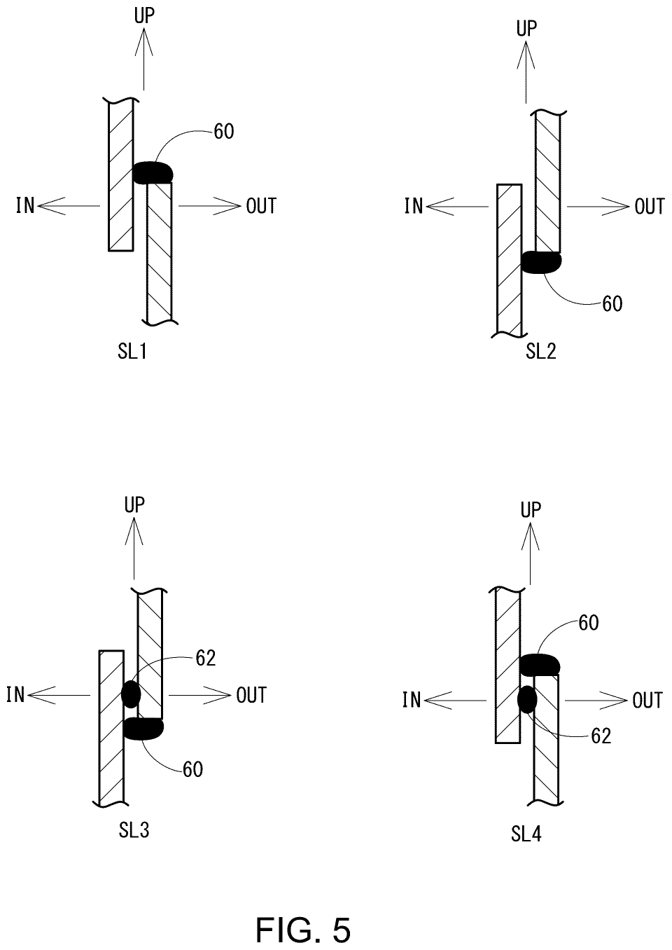

It should be noted that, in the present example, sealing structures having different configurations are employed depending on the orientations of joint lines. These configurations will be described with reference to FIG. 5. Generally, a joint line facing downward as viewed from the outside of the vehicle has a higher waterproofing performance than a joint line facing upward as viewed from the outside of the vehicle. That is, the waterproofing performance is higher in a state SL2 on the upper right of FIG. 5 than a state SL1 on the upper left of FIG. 5. In addition, the greater the number of sealing members disposed at a joint line, the higher the waterproofing performance. For example, the waterproofing performance is higher when both a first seal 60 and a second seal 62 are disposed at a joint line as illustrated in a state SL3 (on the lower left of FIG. 5) and a state SL4 (on lower right of FIG. 5) than when only the first seal 60 is disposed at a joint line as illustrated in the state SL2. Thus, the waterproofing performance increases in the order of the state SL1, the state SL2, and the state SL3. However, due to constraints in parts arrangement, it is difficult to make all joint lines face downward as viewed from the outside of the vehicle. In addition, disposing the first seal 60 and the second seal 62 at all the joint lines causes a problem of increasing costs and manufacturing man-hours. Thus, in the present example, only the first seal 60 is disposed at joint lines facing downward as viewed from the outside of the vehicle, and the first seal 60 and the second seal 62 are disposed at joint lines facing upward. In other words, the number of sealing members disposed at the joint lines facing upward as viewed from the outside of the vehicle is greater than the number of sealing members disposed at the joint lines facing downward. It should be noted that the first seal 60 is a sealing member that can be applied relatively easily, such as a paint seal, for example. The second seal 62 is a sealing member obtained by curing a paste material such as a caulking agent, for example. By changing the number of sealing members depending on the orientations of joint lines as described above, it is possible to reliably ensure the liquid tightness of joint lines and suppress the increase in cost, time, and effort required for ensuring the liquid tightness.

The vehicle further includes a vent duct 44. The vent duct 44 is a duct that communicates between the interior and the exterior of the vehicle. By providing the vent duct 44, it is possible to prevent a phenomenon in which a door cannot be easily closed due to a pressure difference between the interior and the exterior. It should be noted that, although not illustrated in FIG. 1 and FIG. 2, a flap that opens and closes a duct hole 46 is provided at the vent duct 44.

In the related art, the vent duct 44 is often attached to a panel member called a “roof side outer portion”. The roof side outer portion is a metal panel disposed between the roof side inner portion 24 and a design panel made of metal. When the design panel 76 made of resin is employed, the roof side outer portion is no longer required, and thus the vent duct 44 cannot be attached to the roof side outer portion.

Thus, in the present example, the vent duct 44 is attached to the flange portion 42 of the wheel well 19 as illustrated in FIG. 1 and FIG. 2. More specifically, the vent duct 44 is attached immediately behind the wheel arch portion 40. In this case, the vent duct 44 is located on an inner side in the vehicle width direction as contrasted with the related art in which the vent duct 44 is attached to a roof side outer portion. As a result, water and dust entering the vent duct 44 from the outside of the vehicle can be reduced as compared to the related art.

In addition, the vent duct 44 is located on a lower side than in the related art. More specifically, the vent duct 44 in the present example is located below a trunk board 82 (see FIG. 2). The trunk board 82 is a plate member constituting a floor of a luggage space. For example, a spare tire is disposed in a space enclosed by the trunk board 82 and a floor panel (not illustrated). For this reason, the space is referred to as a “spare tire space” below. The vent duct 44 is located below the trunk board 82 and communicates with the spare tire space. With this configuration, most of noises entering the interior of the vehicle from the exterior through the vent duct 44 remain in the spare tire space. Accordingly, noises reaching a passenger are reduced and the comfort of the passenger is increased.

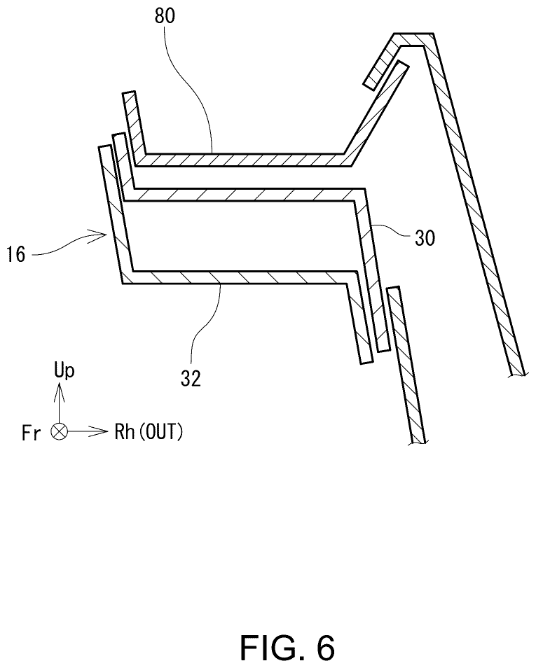

Incidentally, the back door opening 12 having a large size is formed in the rear surface of the vehicle as illustrated in FIG. 2. The rigidity is likely to be lowered in the periphery of the back door opening 12. In the present example, in order to prevent the lowering of the rigidity, a rear flange 36 projecting to the outside of the vehicle is provided at the second pillar 16, and a weatherstrip 72 is attached to the rear flange 36. This configuration will be described with reference to FIG. 4 and FIG. 6.

As illustrated in FIG. 4, the second pillar 16 is formed by joining a second pillar inner portion 32 and a second pillar outer portion 30 to each other. A closed cross section 34 having a substantially rectangular shape is formed between the second pillar inner portion 32 and the second pillar outer portion 30. A joint between the second pillar inner portion 32 and the second pillar outer portion 30 constitutes a front flange 38 or the rear flange 36. The front flange 38 is a flange projecting to the lower side of the vehicle or the front side of the vehicle. The front flange 38 is welded to another member such as the roof side inner portion 24.

The rear flange 36 is a flange projecting to the upper side of the vehicle or the rear side of the vehicle; that is, in a direction corresponding to the outside of the vehicle as viewed from the back door opening 12. The rear flange 36 defines the circumferential edge of the back door opening 12. The rear flange 36 is enclosed and sealed by the weatherstrip 72. Accordingly, entry of water into the second pillar 16 is prevented. In addition, the rear flange 36 rises toward the outside of the vehicle from a surface of the second pillar 16. Thus, the rear flange 36 functions as a barrier that prevents raindrops streaming down the surface of the second pillar 16 from moving to the back door opening 12.

Similarly, each of the roof header 70, the rear end 26, and the lamp housing 18 also includes a rear flange (not illustrated) that projects to the upper side or the rear side of the vehicle and functions as a barrier. All of these rear flanges are enclosed by the weatherstrip 72. As a result, the barriers (i.e., the rear flanges) sealed by the weatherstrip 72 are present over the entire circumference of the back door opening 12.

Here, in the related art, a trough 80 is disposed along the second pillar 16 to prevent entry of water. FIG. 6 is a cross-sectional view of the periphery of the second pillar 16 in a vehicle in the related art. As illustrated in FIG. 6, the trough 80 has a groove shape and functions as a rain gutter. In the related art, the trough 80 is disposed on the upper side of the second pillar 16. In this case, since raindrops are received by the trough 80, entry of water into the back door opening 12 is prevented. However, when the trough 80 is provided, the cross-sectional area of the second pillar 16 is reduced by the depth of the trough 80. When the cross-sectional area of the second pillar 16 is reduced, the rigidity of the vehicle is reduced accordingly.

On the other hand, when the rear flange 36 functioning as a barrier is provided at the second pillar 16 as in the present example, the trough 80 is no longer required and a large cross-sectional area of the second pillar 16 can be ensured. As a result, lowering of the rigidity can be effectively prevented.

As described above, in the present example, the lamp housing 18 has a closed cross section connected to the closed cross section 34 of the second pillar 16. Accordingly, the second pillar 16 and the lamp housing 18 function as one continuous large frame member. As a result, lowering of the rigidity at the circumferential edge of the back door opening 12 can be effectively prevented.

It should be noted that each of the configurations described above is merely an example, and as long as the configuration of the claims are included, other configurations may be changed as appropriate. For example, the arrangement of the vent duct 44 may be changed as appropriate. In addition, the roof side inner portion 24 is not necessarily divided, or may be divided into three or more portions.

### REFERENCE SIGNS LIST

10: Side door opening
12: Back door opening
14: First pillar
16: Second pillar
18: Lamp housing
19: Wheel well
20: Wheel well outer portion
22: Wheel well inner portion
24: Roof side inner portion
26: Rear end
28: Opening panel
30: Second pillar outer portion
32: Second pillar inner portion
34: Closed cross section
36: Rear flange
38: Front flange
40: Wheel arch portion
42: Flange portion
44: Vent duct
46: Duct hole
50: Front side roof side inner portion
52: Rear side roof side inner portion
60: First seal
62: Second seal
70: Roof header
72: Weatherstrip
76: Design panel
80: Trough
82: Trunk board

1. A vehicle rear structure comprising:
a first pillar defining a rear end edge of a side door opening;
a second pillar defining an interface between a rear surface and a side surface of a vehicle;
a lamp housing connected to a lower end of the second pillar;
a wheel well disposed between and connected to the first pillar and the lamp housing; and
a roof side inner portion filling, without a gap, an area enclosed by the first pillar, the second pillar, the lamp housing, and the wheel well.

2. The vehicle rear structure according to claim 1, further comprising a vent duct communicating between an interior and an exterior of the vehicle, wherein
the wheel well includes
a wheel arch portion along a circumferential surface of a rear wheel, and
a flange portion projecting outward in a radial direction of the rear wheel from the wheel arch portion, and
the vent duct is disposed at the flange portion and below a trunk board.

3. The vehicle rear structure according to claim 1, wherein
a circumferential edge of the roof side inner portion is joined to the first pillar, the second pillar, and the wheel well,
one or more sealing members are provided at a plurality of joints between the roof side inner portion and other members, and
the number of the sealing members provided at joints facing upward when viewed from the exterior of the vehicle out of the plurality of joints is greater than number of the sealing members provided at joints facing downward when viewed from the exterior of the vehicle out of the plurality of joints.

4. The vehicle rear structure according to claim 1, further comprising:
a roof header defining an upper edge of a back door opening;
a rear end defining a lower edge of the back door opening; and
a weatherstrip attached to a circumferential edge of the back door opening, wherein
each of upper ends of a pair of second pillars, each identical to the second pillar, is joined to a respective one of both ends of the roof header in a vehicle width direction,
each of lower ends of a pair of lamp housings, each identical to the lamp housing, is joined to a respective one of both ends of the rear end in the vehicle width direction, and
the second pillar includes a rear flange projecting toward the outside of the vehicle, the rear flange being sealed by the weatherstrip.

5. The vehicle rear structure according to claim 1, further comprising a design panel covering at least the roof side inner portion from the outside and constituting an outer surface of the vehicle, wherein the design panel is made of resin.
